(19) United States
(12) Patent Application Publication
(10) Pub. No.: US 2021/0360094 A1
(43) Pub. Date: Nov. 18, 2021

(54) EYESIGHT CORRECTIVE TOUCH SCREEN PROTECTOR

(71) Applicant: Kassem Bazzi, Deerborn, MI (US)

(72) Inventor: Kassem Bazzi, Deerborn, MI (US)

(21) Appl. No.: 15/931,162

(22) Filed: May 13, 2020

(51) Int. Cl. H04M 1/02; H04B 1/3888

(52) U.S. Cl. CPC H04M 1/027; H04B 1/3888

(57) ABSTRACT

A touch screen protector for a portable electronic device incorporates near-point corrective lenses into a reinforced glass film layer. The protector is planar, rigid, and fabricated from lightweight, transparent impact-resistant material. The protector provides a focal length within a range commonly associated with reading glasses. Larger versions of the invention can be adapted for use on devices such as ipads, personal computer screens, and computer monitor displays.

### BACKGROUND OF THE INVENTION

### 1. Field of the Invention

Generally, the invention relates to vision aid devices. Particularly, the invention relates to devices that aid a viewer to read a screen display. Specifically, the invention relates to visual properties of mobile device screen protectors.

### 2. Background of the Invention

Mobile devices, and in particular, mobile phones and table computers, include fragile display screens. A myriad of accessories are available for protective purposes, such as device cases designed to cushion and protect the device from impact, so that the display screen will not fracture.

Different phone models, ipads, kindles, and other devices with viewing screens require an accessory screen protector. Screen protectors are made in different sizes, depending on the model of the device. The protectors can be polarized and made in a variety of styles, colors, and prints. Available protective mobile device cases include a rigid or cushioned material into which the mobile device is inserted, and which surrounds the device. A common method is to have an outer silicone layer of the case and an inner rigid layer to protect the device apertures for inserting chargers and headphones.

Prescriptive reading magnifiers are not available for display screens. Consequently, people without corrective prescriptions using various mobile devices, ipads, and PCs often must wear their eyewear before reading a display and obtaining information conveyed. This practice of requiring eyewear to read display screens is a nuisance for the user, who often needs to read a screen display in the absence of eyewear.

Therefore, what is needed is a mobile device screen protector that provides the function of prescription eyewear. What is further needed is a smart phone case that houses the prescriptive corrective screen protector. What is still further needed is a corrective screen protector provided in a range of strengths similar to the strengths most common in reading glasses. Finally, what is needed are eyesight-correcting screen protectors adapted to fit various screen sizes for ipads and PCs.

### BRIEF SUMMARY OF THE INVENTION

It is an object of the present invention to advantageously provide a screen protector for a mobile device, in which the screen protector is formed with corrective eyesight capability to better view a display. A further object of the present invention is to provide such screen protectors a range of strengths common in reading glasses. It is yet a further object of the present invention to provide such a screen protector that permanently incorporates a corrective means into the main screen protector planar shield. Finally, it is an object of the present invention to provide such a screen protector with corrective eyesight capability, including magnification of the display, is sized for a display screen of an ipad, PC, or other personal device and display monitor.

### BRIEF DESCRIPTION OF THE SEVERAL VIEWS OF THE DRAWINGS

FIG. 1 is a view in perspective of the inventive device case with corrective screen protector.

FIG. 2 is a view in perspective of the inventive screen protector.

FIG. 3 is a view in perspective of an alternative embodiment with a prescriptive eyesight corrective region formed integrally with a mobile device screen protector.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

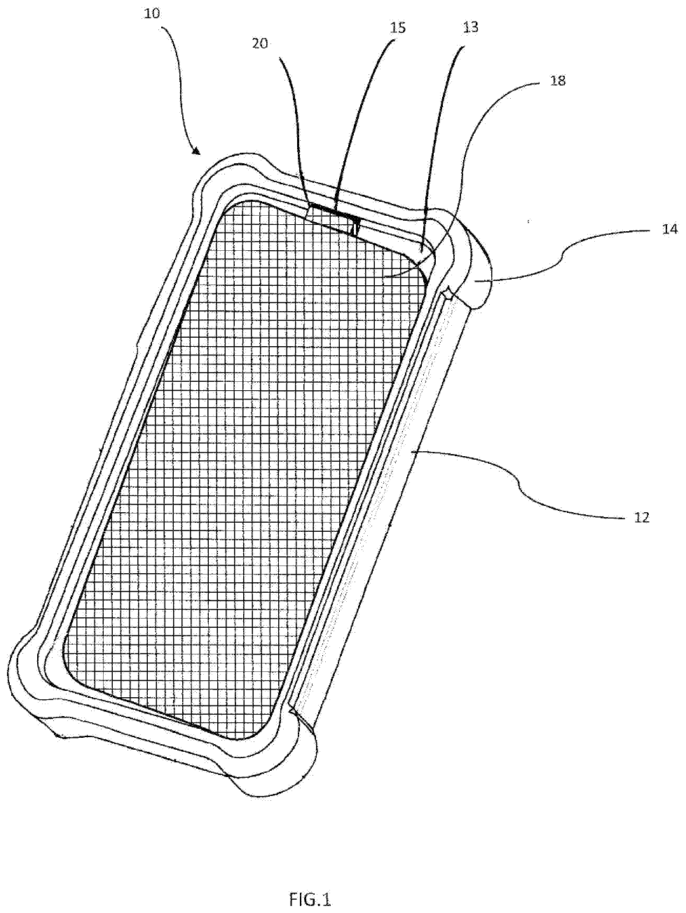

A particular embodiment of the present invention is illustrated in FIG. 1, which shows a mobile device case 10 containing a mobile device 12 with a viewing screen display 13. The mobile device case 10 has a housing 14 formed in the general shape of the device 12. The housing has a groove 15. The housing 14 has portions defining an interior space sized to releasably retain the mobile device 12. A screen protector 18 is removably secured to the case 10 through engagement to the housing 14. The screen protector 18 has a lip 20 that engages the groove 15 and holds the screen in a friction fit.

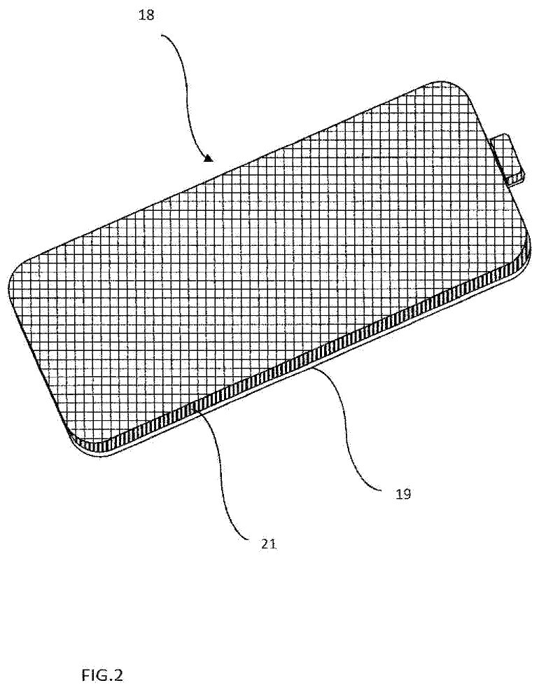

Looking at FIG. 2, the screen protector 18 is a substantially rigid, substantially planar piece made of impact-resistant material, such as a polycarbonate material. The screen protector 18 has a thin adhesive layer 19 and a corrective layer 21. The adhesive layer 19 is formed to removably attach to the display screen 13. The corrective layer 21 is formed with corrective eyesight capability in a variety of prescription strengths commonly associated with reading glasses that magnify and resolve images for a viewer.

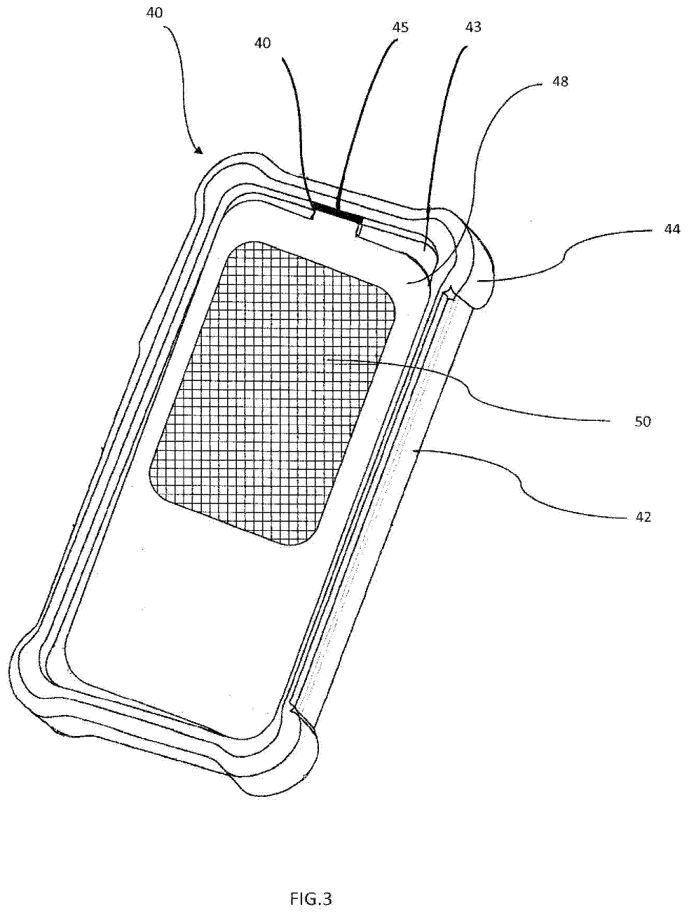

An alternative embodiment of the present invention is displayed in FIG. 3, which shows a mobile device case 40 containing a mobile device 42 with a viewing screen display 43. The mobile device case 40 has a housing 44 formed in the general shape of the device 42. The housing has a groove 45. The housing 44 has portions defining an interior space sized to releasably retain the mobile device 42. A screen protector 48 is removably secured to the case 40 through engagement to the housing 44. The screen protector 48 has a lip 40 that engages the groove 45. The screen protector 40 has a prescriptive region 50 formed integrally with the corrective layer 48. The corrective layer is a substantially rigid, substantially planar piece made of substantially transparent impact-resistant material, such as a polycarbonate material. The prescriptive region 50 is formed with corrective eyesight capability in a variety of prescription strengths commonly associated with reading glasses

In conclusion, the present invention in using the aforementioned structure has assuredly achieved anticipated effectiveness, moreover, contents of the present invention have not been publicly disclosed prior to this application, and novelty, advancement and industrial practicability of the present invention clearly comply with essential elements as required for a new patent application. Accordingly, a new patent application is proposed herein. It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A mobile device case for releasably retaining a mobile device with a viewing screen display, the mobile device case comprising:
a housing including a groove and defining an interior space sized to releasably retain said mobile device;
a substantially rigid, transparent and at least substantially planar screen protector removeably engageable with a portion of said housing, said screen protector having:
a lip portion formed to engage said groove; and,
a substantially rigid, transparent and at least substantially planar screen corrective layer, said corrective layer including at least one vision-correcting portion formed integrally therewith.

2. A screen protector for a display screen of a device, said screen protector comprising:
a substantially rigid, transparent and at least substantially planar screen protector removeably engageable with said display screen, said screen protector having:
a substantially rigid, transparent and at least substantially planar screen corrective layer, said corrective layer including at least one vision correcting portion formed integral with said corrective layer.

3. A mobile device case for releasably retaining a mobile device with a viewing screen display, the mobile device case comprising:
a housing including a groove and defining an interior space sized to releasably retain said mobile device;
a substantially rigid, transparent and at least substantially planar screen protector removeably engageable with a portion of said housing, said screen protector having:
a lip portion formed to engage said groove; and,
a substantially rigid, transparent and at least substantially planar vision-correcting layer.
